(19) United States
(12) Patent Application Publication
(10) Pub. No.: US 2002/0092839 A1
(43) Pub. Date: Jul. 18, 2002

(54) Method of making an integrated circuit

(76) Inventors: Bing Lu, Gilbert, AZ (US); Eric Weisbrod, Phoenix, AZ (US); Doug J. Resnick, Phoenix, AZ (US); Kevin J. Nordquist, Higley, AZ (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 09/997,373

(22) Filed: Nov. 29, 2001

Related U.S. Application Data
(63) Continuation-in-part of application No. 09/630,073, filed on Aug. 1, 2000.

(51) Int. Cl. F27B 5/14

(52) U.S. Cl. 219/390; 219/392; 219/411; 392/416; 392/418

(57) ABSTRACT

A heating apparatus has an upper heating element and a lower hotplate. As part of the process of making integrated circuits, the heating apparatus is preheated using both the upper heating element and the hotplate. A substrate, which may be a semiconductor substrate or a photolithography mask, is then inserted into the preheated heating apparatus. Typically, the purpose of the heating is to cure the photoresist that is on the substrate and has already been exposed to a desired pattern. By having both the top heating element and the hotplate active during the preheating and during the curing, the photoresist is cured uniformly, which improves the pattern in the photoresist that occurs after a solvent has been applied to perform the selective removal of the photoresist in accordance with the exposed pattern. Subsequent use of the substrate results in integrated circuits made from semiconductor substrates.

### RELATED APPLICATION

This application is a continuation-in-part of Ser. No. 09/630,073, filed Aug. 1, 2000, entitled “Dual Heating Element Apparatus for Resist Bake,” abandoned, and assigned to the assignee hereof.

### FIELD OF THE INVENTION

The present invention is related to the field of semiconductor fabrication and more particularly to heating techniques for improving the manufacture of integrated circuits.

### RELATED ART

The fabrication of integrated circuit involves a series of processing steps: depositing one or more layers of materials; applying of a layer of resist material; performing post apply bake (PAB); exposing the resist through a photomask (fabricated in similar process) containing the integrated circuit pattern to a form of radiation, such as photons or electrons; performing post exposure bake (PEB); developing the resist; transferring the pattern to the substrate through an etch step; and removing the resist.

PAB is performed to remove the remaining solvent and anneal any stress in the resist film. Stress in the film may result in loss of adhesion of the resist to the substrate or erratic developing or etching during subsequent processing. Post exposure bake (PEB) is performed to reduce the standing wave in the dose image and thermally catalyze chemical reactions that amplify the latent bulk image in chemically amplified resists, which are used to obtain the high sensitivity and high resolution required in advanced processes. As the semiconductor device continues to shrink in size, process specifications place stringent requirements on critical dimension (CD) control. Uniform baking is critical due to PEB sensitivity of the resist. Variations in PEB temperature of as little as 1° C. can result in a 5 to 10 nanometer variation in the final CD. Therefore it is imperative to have a baking apparatus with an extremely uniform temperature (i.e., no temperature gradient).

Historically, the best method of achieving uniform baking temperature across a semiconductor substrate included contact baking. As its name suggests, contact baking requires physical contact between the substrate backside and a heated surface. Unfortunately, the physical contact required in contact baking processes can produce highly undesirable contaminants on the hotplate surface that can adversely affect the temperature uniformity achieved on subsequently processed substrates . In addition, the physical contact between the substrate and the heated surface is typically enhanced in a contact bake process by creating a vacuum between the substrate backside and the heated surface. For membrane mask photolithography processes (e.g., X-ray, EPL, Ion projection), however, the vacuum required to maintain adequate physical contact with the hotplate can damage the extremely fragile membranes. Moreover, the need for thermal uniformity is even more critical in such processes due to three dimensional complexity of the mask.

To prevent the contamination and vacuum damage that can characterize contact bake processes, proximity heating may be employed as a PEB process. In a typical proximity heating process, a resist coated substrate is suspended in a chamber several microns above a single heating element. Unfortunately, the conventional proximity bake process can result in an unacceptably large temperature gradient within the bake chamber that can produce a temperature gradient in the resist film that translates into a CD variation. In addition, the typical proximity bake process requires an unacceptably long time to bring the substrate chamber to an acceptable processing temperature (referred to herein as the baking response time) thereby reducing throughput and introducing additional variability into the baking process. It would therefore be highly desirable to employ a baking process and apparatus that substantially eliminates temperature gradients within the bake chamber, achieves adequate response time, independent upon the shape or size of the substrate, and avoids the drawbacks of the conventional bake processing.

### BRIEF DESCRIPTION OF THE DRAWINGS

The present invention is illustrated by way of example and not limitation in the accompanying figure, in which like references indicate similar elements, and in which:

FIG. 1 is cross sectional view of a heating apparatus according to one embodiment of the present invention;

FIG. 2 is flow diagram of a method of making an integrated circuit according to an embodiment of the invention using the heating apparatus of FIG. 1;

FIG. 3 is a diagram of an apparatus useful in performing a portion of the method shown in FIG. 2; and

FIG. 4 is a diagram of another apparatus useful in performing another portion of the method shown in FIG. 2.

Skilled artisans appreciate that elements in the figure are illustrated for simplicity and clarity and have not necessarily been drawn to scale. For example, the dimensions of some of the elements in the figure may be exaggerated relative to other elements to help improve the understanding of the embodiments of the present invention.

### DETAILED DESCRIPTION

Referring to FIG. 1, a heating apparatus 100 suitable for use with advance resist bake or PEB processes according to one embodiment of the present invention is depicted. In the depicted embodiment, heating apparatus 100 includes a chassis or frame 101 that forms an enclosure. Typically, frame 101 is comprised of stainless steel or another material suitable for use in a semiconductor fabrication facility.

The frame 101 defines an opening across which an access door 105 is attached, typically with a hinge mechanism. When access door 105 is in a closed position, frame 101 and access door 105 define a heating chamber 103 within frame 101. Access to chamber 103 is enabled when access door 105 is opened.

The depicted embodiment of heating apparatus 100 includes a first heating element, identified in FIG. 1 as upper heating element 102, attached to an upper surface of the interior of frame 101 such that upper heating element 102 defines an upper boundary 112 of chamber 103. Apparatus 100 further includes a second heating element, identified as lower heating element 106, attached to a lower surface of the interior of frame 101. The heating elements 102 and 106 are configured to receive energy from a source of electrical power (not depicted) and are enabled to generate a controllable elevated temperature in the range of approximately 50 to 300° C. when connected to the electrical energy source. An insulator 110 is positioned between upper heating element 102 and frame 101 and between lower heating element 106 and frame 101 to increase the thermal efficiency of heating apparatus 100. Insulator 110 may comprise any suitable thermal insulator including air or quartz.

A hotplate 104 is positioned in contact with lower heating element 106 such that hotplate 104 defines a lower boundary 114 of chamber 103. Typically, the hotplate comprises a thermally conductive material such that the surface temperature of hotplate 104 is controllably increased when the source of electrical energy is connected to lower heating element 106. In one embodiment, hotplate 104 is capable of obtaining temperatures in the range of approximately 50 to 300° C. When heated by lower heating element 106, hotplate 104 radiates heat to chamber 103.

Loading pins 108 extend from hotplate 104 into chamber 103 to support a semiconductor substrate 120 at a selectable displacement above an upper surface of hotplate 104. In one embodiment, the vertical displacement between a lower surface of upper heating element 102 and an upper surface of hotplate 104 is approximately 11 mm and the loading pins 108 are enabled to support the substrate 120 vertically displace above hotplate 104 by approximately 500 um. In the depicted embodiment, the substrate 120 is coated with a resist film 122 that is of a material that can be patterned due to its ability to be selectively exposed. This capability is present in materials commonly called photoresist.

Substrate 120 may comprise a product substrate in which integrated circuits will be formed. Alternatively, substrate 120 will be used to form a photolithography mask. In such case the type of mask may be any and include in particular, electron projection lithograph, such as SCALPEL and PREVAIL. In either embodiment, it is highly desirable to minimize any temperature gradient within chamber 104 to minimize temperature variations within resist film 122 thereby facilitating adequate CD control across the substrate. The incorporation of upper heating element 102 into the depicted embodiment of heating chamber 101 substantially reduces temperature gradients within chamber 103 over conventionally designed resist bake ovens, in which only a single heating element is incorporated.

By improving the temperature uniformity achieved in chamber 103, the dual heating element apparatus 100 is less sensitive to positioning variations due the positioning limitations of loading pins 108. Whereas precise loading pin control is required in a conventional single heating element chamber to ensure that all portions of the substrate are at precise, and constant, displacement above the heating element, the apparatus 100 as disclosed herein relaxes demands on the accuracy of the loading pins thereby greatly enhancing the production worthiness of the chamber.

In addition, by providing a second heating element, heating apparatus 100 achieves a PEB response time that is superior to single heating element chambers. The improved PEB response time translates directly into increased throughput. Because of the number of masks required to fabricate complex semiconductor products, many fabrication facilities are throughput constrained by photolithography and, therefore, any improvement in photolithography throughput is highly desirable.

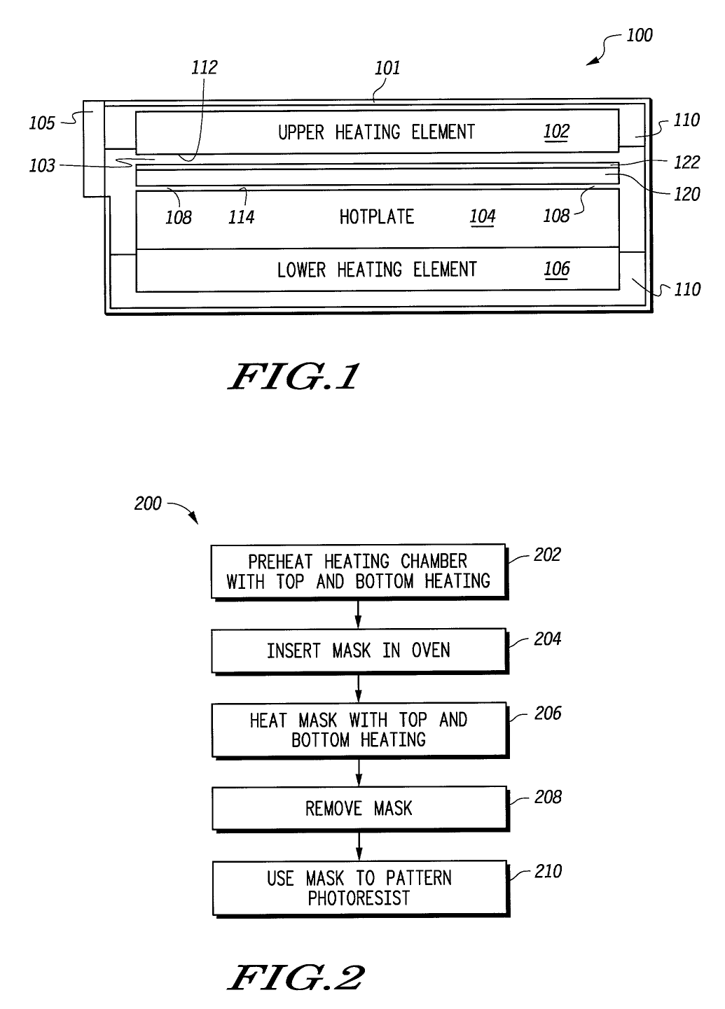

Shown in FIG. 2 is a method 200 comprising steps 202, 204, 206, 208, and 210 for making an integrated circuit using the heating chamber of FIG. 1. As shown in step 202, the heating chamber 100 is preheating using both the upper heating element 102 and the lower hotplate 104. Both heating element 102 and hotplate 104 are contemporaneously active and thus preheat the heating chamber 100. Following step 202 is step 204 in which the substrate 120 with resist 122 on it is inserted into heating chamber 100 and rests on supporting pins 108. Resist 122 has already been exposed according to a desired pattern prior to insertion. In addition, substrate 120 may beneficially be inserted into heating chamber 100 after application of resist 122 but before it is exposed. This a post apply bake (PAB). After exposure of resist 122, there is exposed photoresist and unexposed photoresist in resist 122. The insertion into heating chamber 100 is to cure the photoresist to make the portion that is to be removed even more distinct from that which is to remain. Step 206 follows in which the substrate 120 and resist 122 are heated very uniformly by virtue of the heating provided by heating element 102 and hotplate 104 since both are contemporaneously active. As shown for step 208, substrate 120 is removed from heating chamber 100. Substrate 120 is then subjected to a solvent so that resist 122 has photoresist selectively removed to provide the desired pattern of photoresist in resist 122. An etch process then provides for putting a pattern into substrate 120 in accordance with the pattern of the photoresist that remained on substrate 120. If the substrate is a semiconductor substrate, then processing continues until the completed integrated circuit is provided. If the substrate is a photolithographic mask, then step 210 is applicable. A semiconductor substrate has photoresist applied to it. The mask 120 is then used to provide a pattern onto this photoresist in accordance with the pattern on the mask 120. This patterned photoresist is cured and selectively removed by a solvent to provide a pattern in the photoresist on the semiconductor substrate in accordance with the pattern on the mask 120. Processing continues until an integrated circuit is formed.

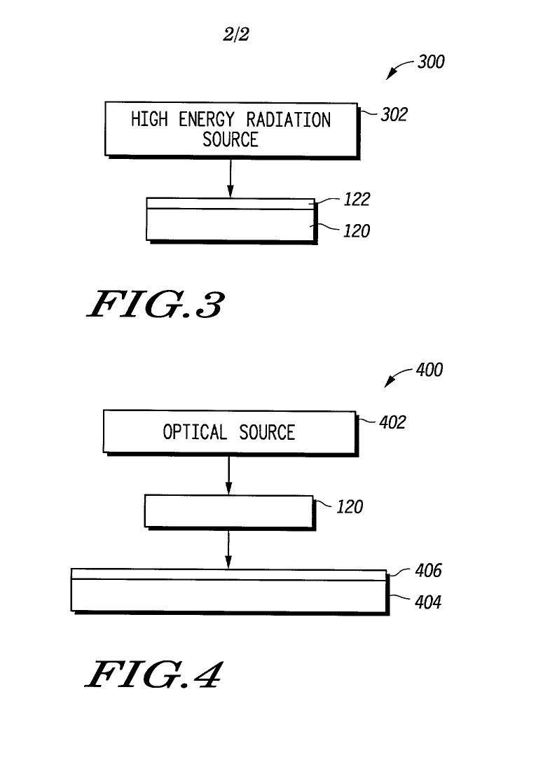

Shown in FIG. 3 is an arrangement 300 comprising a programmable high energy radiation source 302, which may, for example, be a laser source or an electron beam source, substrate 120, and resist 122 on substrate 120 for patterning resist 122 for the case in which substrate 120 is to be used as a mask. Laser source 302 provides the necessary radiation to expose photoresist. This, radiation exposes resist 122 in accordance with a pattern programmed into programmable laser source 302. After this exposure, substrate 120 is inserted into heating chamber 100 for curing resist 122 as described for steps 204 and 206 of FIG. 2. Subsequently, after the requisite processing, substrate 120 becomes mask 120. Substrate 120 may also be inserted into heating chamber 100 after application of photoresist 122, but before photoresist 122 is patterned.

Shown in FIG. 4 is an arrangement 400 comprising an optical source 402, mask 120, a semiconductor substrate 404, and a resist 406 that has been applied over semiconductor substrate 404. Optical source 402 provides any appropriate radiation, which may be, for example, photons, electrons, or ions. This, radiation, in some form, passes through mask 120 and exposes resist 406 in accordance with the pattern on mask 120. Mask 120 will typically have a significantly smaller area than semiconductor substrate 404 and be controlled by a lithography system, for example, a stepper. Mask 120 and semiconductor substrate 404 will be moved in relation to each other until all of resist 406 is exposed as desired with regard to mask 120. After resist 406 is exposed in accordance with the pattern of mask 120, it is cured in a heating apparatus such as heating chamber 100 shown in FIG. 1. Resist 406 may also be inserted into heating chamber 100 after application of resist 406 but before resist 406 is exposed. Semiconductor substrate 404 is subsequently removed from such heating chamber, and resist 406 is then selectively removed to provide a pattern in accordance with the pattern in mask 120. Semiconductor substrate 404 is subsequently processed to produce integrated circuits.

As a result of the uniform heating, photoresist is cured so that the critical dimension (CD) control is not adversely impacted by the necessary heating steps. The arrangement of the heating elements allows for a relatively wide range of locations within the chamber that still provide the desired uniform temperature.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed.

1. A heating apparatus for heating a substrate, comprising:
a frame;
a door hinged to the frame, wherein the door and frame define a chamber when the door is in a closed position;
a lower heating element attached to a lower surface of the interior of the frame, wherein the lower heating element is configured to receive energy from a source of electrical power and further wherein the heating element is capable of obtaining a controllable elevated temperature when connected to the source of electrical energy;
an upper heating element attached to an upper surface of the interior of the frame wherein the upper heating element defines an upper boundary of the chamber wherein the upper heating element is configured to receive energy from a source of electrical power wherein the heating element is capable of obtaining a controllable elevated temperature when connected to the source of electrical energy;
a hot plate in contact with the lower heating element, wherein the hot plate defines a lower boundary of the chamber that a is a first distance from the upper boundary at a time of entry of the substrate into the heating apparatus and during the heating of the substrate; and
support means coupled to the hot plate for supporting the substrate and ensuring that the substrate is displaced from the hot plate.

2. (Amended) The apparatus of claim 1, wherein the support means comprises a plurality of loading pins enabled to extend the chamber from the hotplate.

3. The apparatus of claim 1, wherein the heating elements are enabled to obtain a temperature in the range of approximately 50 to 300° C.

4. The apparatus of claim 1, further comprising a thermal insulator displaced between the upper heating element and the upper surface of the frame interior and between the lower heating element and the lower surface of the frame interior.

5. The apparatus of claim 1, wherein the upper boundary of the chamber and the lower boundary of the chamber are vertically displaced by approximately 11 mm.

6. A method for making an integrated circuit, comprising;
providing a heating chamber having an upper heating element and a lower hot plate;
preheating the heating chamber;
inserting a mask between the upper heating element and the lower hot plate after the step of preheating;
heating the mask by having both the upper heating element and the lower hot plate contemporaneously active;
removing the mask from the heating chamber;
providing a semiconductor substrate;
applying photoreist to the semiconductor substrate;
exposing the photoresist on the semiconductor substrate through the mask in accordance with a pattern on the mask;
further processing the semiconductor substrate to complete the making of the integrated circuit.

7. The method of claim 6, further comprising:
depositing photoresist on the mask;
patterning the photoresist on the mask prior to the step of inserting the mask;
and removing a portion of the photoresist on the mask after the step of removing the mask.

8. A method for heating a substrate comprising;
providing a heating chamber having an upper heating element and a lower hot plate that are a first distance apart;
providing a plurality of support pins in the lower hot plate that have a length less than the first distance;
preheating the heating chamber with the upper heating element and the hot plate;
inserting the substrate between the upper heating element and the lower hot plate that are the first distance apart after the step of preheating,
continuing heating the heating chamber substrate, while the substrate is in the heating chamber, with the upper heating element and the lower hot platet; and
removing the substrate from the heating chamber with the upper heating element and the lower hot plate at the first distance apart.

9. The method of claim 8, wherein the substrate is a semiconductor substrate.

10. The method of claim 8, wherein the substrate is a photolithography mask.

11. The method of claim 8, further comprising applying photoresist to the substrate prior to the step of inserting.

12. A method for making an integrated circuit, comprising;
providing a heating chamber having an upper heating element and a lower hot plate;
preheating the heating chamber by having both the upper heating element and the lower hot plate contemporaneously active;
inserting a mask between the upper heating element and the lower hot plate after the step of preheating;
heating the mask by having both the upper heating element and the lower hot plate contemporaneously active;
removing the mask from the heating chamber;
providing a semiconductor substrate;
applying photoreist to the semiconductor substrate;
exposing the photoresist on the semiconductor substrate through the mask in accordance with a pattern on the mask;
further processing the semiconductor substrate to complete the making of the integrated circuit.

13. The method of claim 12, wherein the mask is a photolithographic mask.

14. The method of claim 12, further comprising applying photoresist to the mask prior to the step of inserting the mask.

15. The method of claim 14, wherein the mask is an electron projection lithography mask.

16. The method of claim 14, wherein the heating chamber is further characterized as having support means coupled to the hot plate for supporting the substrate and ensuring that the substrate is displaced from the hot plate

17. A method for making an integrated circuit, comprising;
providing a heating apparatus for heating a mask comprising;
a frame;
an upper heating element coupled to the frame;
a lower hotplate coupled to the frame a first distance from the upper heating element, wherein the first distance is for insertion, heating, and removal of the substrate; and
a plurality of support pins in the lower hot plate that have a length less than the first distance for supporting the substrate and displacing the substrate from the hot plate.
preheating the heating apparatus by having both the upper heating element and the lower hot plate contemporaneously active;
placing the mask on the plurality of support pins;
heating the mask by having both the upper heating element and the lower hot plate contemporaneously active;
removing the mask from the heating chamber;
providing a semiconductor substrate;
applying photoreist to the semiconductor substrate;
exposing the photoresist on the semiconductor substrate through the mask in accordance with a pattern on the mask; and
further processing the semiconductor substrate to complete the making of the integrated circuit.

18. The method of claim 17, wherein the mask is a an electron projection lithography mask.

19. The method of claim 17, further comprising applying photoresist to the mask prior to the step of inserting the mask.

20. The method of claim 19 further comprising:
selectively removing, after the step of removing the mask, a portion of the photoresist on the mask to provide a pattern in the photoresist on the mask; and
patterning the mask in accordance with the pattern in the photoresist on the mask.
